(19) United States
(12) Patent Application Publication
(10) Pub. No.: US 2024/0293276 A1
(43) Pub. Date: Sep. 5, 2024

(54) ELECTRIC BED

(71) Applicant: Chuan-Hang SHIH, Lukang Township (TW)

(72) Inventors: Chuan-Hang SHIH, Lukang Township (TW); Yu-Chi YANG, Lukang Township (TW)

(73) Assignee: Chuan-Hang SHIH, Lukang Township (TW)

(21) Appl. No.: 18/659,748

(22) Filed: May 9, 2024

Related U.S. Application Data
(63) Continuation-in-part of application No. 18/130,045, filed on Apr. 3, 2023.
(63) Continuation-in-part of application No. 18/130,175, filed on Apr. 3, 2023.

(30) Foreign Application Priority Data
Dec. 12, 2022 (TW) 111149356
Dec. 16, 2022 (TW) 111148572

(51) Int. Cl. A61G 7/015; A61G 7/018

(52) U.S. Cl. CPC A61G 7/015; A61G 7/018

(57) ABSTRACT

An electric bed includes a base frame and a sliding unit. The base frame is provided with two parallel guide rails. Each of the two guide rails has a vertical wall, top and bottom walls extending respectively from top and bottom edges of the vertical wall, and a stopping wall extending upwardly from the bottom wall. The sliding unit includes a frame located above the two guide rails, and two slide portions disposed on a bottom side of the frame, and respectively and slidably disposed to the two guide rails in a way that the sliding unit is reciprocatingly slidable related to the base frame. As a result, a bed frame of the electric bed can slide towards the head of the electric bed when raising a user's back. The electric bed provides a sturdy and durable structure with a slight increase in weight.

### CROSS-REFERENCE TO RELATED APPLICATIONS

This application is a continuation-in-part of U.S. patent application Ser. Nos. 18/130,045 and 18/130,175 filed Apr. 3, 2023, which are incorporated by reference herein in their entirety.

### BACKGROUND OF THE INVENTION

### 1. Field of the Invention

The present invention relates generally to furniture and more particularly, to an electric bed.

### 2. Description of the Related Art

Conventional electric beds are usually provided with functions of lifting back and legs of the user so as to meet the basic needs of posture adjustment. However, the conventional electric beds may have inconveniences in use. For example, when the electric bed lifts the user's back, the pressure acting on the abdomen of the user will increase as the inclination angle of the user's back increases because the buttocks of the user still remain stationary. For pregnant women or obese people, they will need to adjust their sitting posture during the process of lifting their back to reduce the pressure on their abdomen. If the user is unable to move by himself/herself, a caregiver may need to help the user to adjust his/her posture when the electric bed lifts the user's back, resulting in increase of the burden on the caregiver.

In addition, when conventional electric bed lifts the user's back, the user's shoulder will gradually move away from the head of the bed, resulting in that it is difficult for the user to access items placed on the bedside table or near the head of the bed. That is, the conventional electric beds are inconvenient in use. To solve the aforesaid issue, an improved electric bed having the design that the bed frame moves towards the head of the bed when the electric bed lifts the user's back is now commercially available. However, the structural strength of such a bed frame with a sliding design is insufficient. Especially, the guide rails are prone to deformation when bearing load for a long time. If the structural strength of the guide rails is to be increased by using reinforced materials, it will increase the entire weight of the bed frame, which is not conducive to transportation.

### SUMMARY OF THE INVENTION

The present invention has been accomplished in view of the above-noted circumstances. It is an objective of the present invention to provide an electric bed, which enables the bed frame thereof to slide towards the bed head when lifting the user's back with a sturdy and durable structure and a slight increase in weight.

To attain the above objective, the present invention provides an electric bed comprising a base frame and a sliding unit. The base frame includes two guide rails extending parallel to a back-and-forth direction. Each of the two guide rails has a vertical wall, a top wall extending outwardly from at least a part of a top edge of the vertical wall, a bottom wall extending outwardly from at least a part of a bottom edge of the vertical wall, and a stopping wall extending upwardly from at least a part of the bottom wall. The sliding unit comprises a frame located above the two guide rails, and two slide portions disposed on a bottom side of the frame. The two slide portions are respectively and slidably disposed to the two guide rails in a way that the sliding unit is reciprocatingly slidable related to the base frame in the back-and-forth direction. As a result, a bed frame of the electric bed can slide towards the head of the electric bed when the electric bed lifts a user's back with a sturdy and durable structure and a slight increase in weight.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a top perspective view of an electric bed according to a preferred embodiment of the present invention;

FIG. 2 is a bottom perspective view of the electric bed of the preferred embodiment of the present invention;

FIG. 3 is a perspective view, showing that the electric bed of the preferred embodiment of the present invention is in a state of use;

FIG. 4 is an enlarged top perspective view, showing a part of the electric bed of the preferred embodiment of the present invention in the state of use; and

FIG. 5 is an enlarged bottom perspective view, showing a part of the electric bed of the preferred embodiment of the present invention in the state of use.

### DETAILED DESCRIPTION OF THE INVENTION

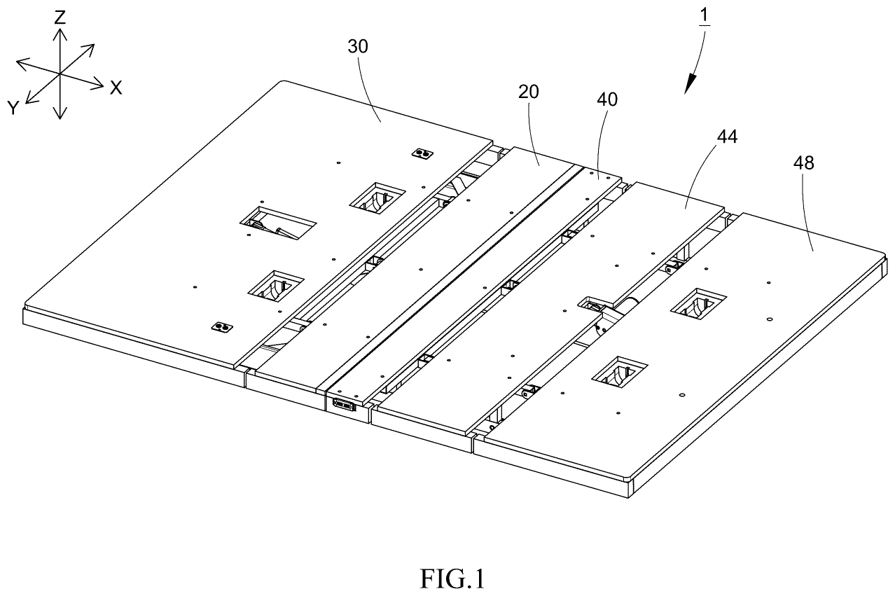

The structure and technical features of the present invention will be detailedly described hereunder by an embodiment and accompany drawings. As shown in FIGS. 1-3, an electric bed 1 provided by a preferred embodiment of the present invention comprises a base frame 10, a rear frame 18, a sliding unit 20, a back supporting unit 30, two front linkages 38, a buttock supporting unit 40, a thigh supporting unit 44, a lower leg supporting unit 48, and two actuators 50. For ease of illustration, in the drawings the arrow X indicates the back-and-front direction, the arrow Y indicates the left-and-right direction, and the arrow Z indicates the up-and-down direction; however, this is not intended to limit the scope of the patent.

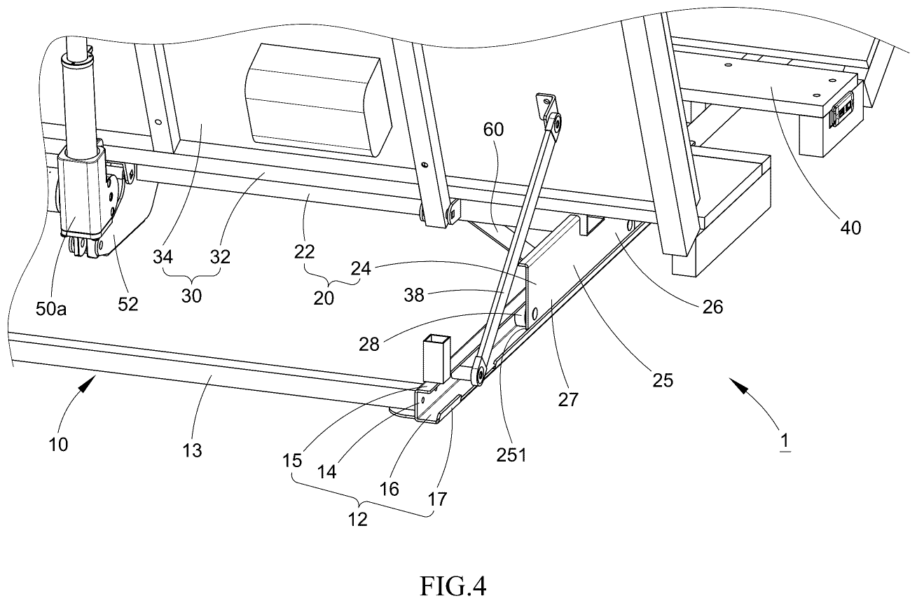

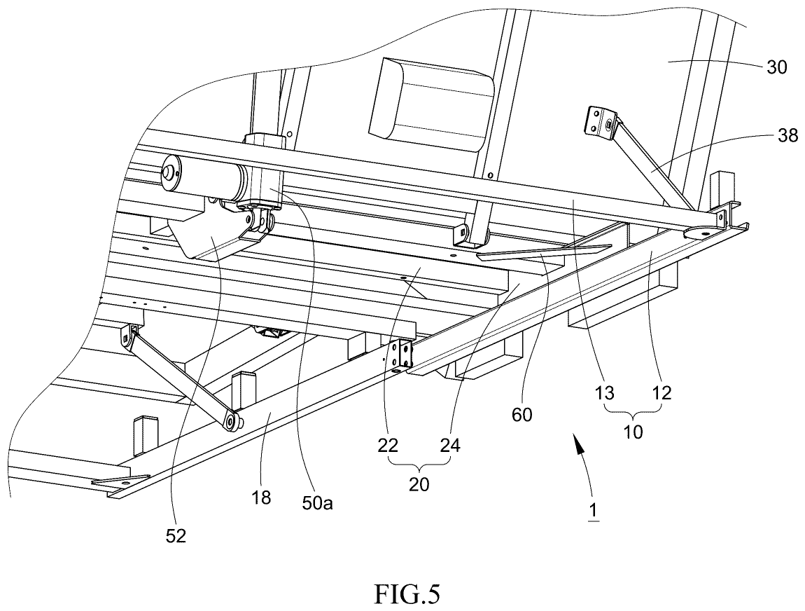

The base frame 10 comprises two guide rails 12 extending parallel to the back-and-front direction X, and a front rod 13 connecting the front ends of the two guide rails 12. As shown in FIGS. 4 and 5, each of the two guide rails 12 has a vertical wall 14, a top wall 15 extending outwardly from the top edge of the vertical wall 14, a bottom wall 16 extending outwardly from the bottom edge of the vertical wall 14, and a stopping wall 17 extending upwardly from a part of an outer side of the bottom wall 16. Specifically, the two top walls 15 extend respectively and outwardly from the two vertical walls 14 in opposite directions away from each other, and the two bottom walls 16 extend respectively and outwardly from the two vertical walls 14 in opposite directions away from each other. However, in another embodiment, the two top walls 15 may extend respectively and outwardly from the two vertical walls 14 towards each other, and the two bottom walls 16 may extend respectively and outwardly from the two vertical walls 14 towards each other.

The rear frame 18 is a substantially rectangular frame and pivotally connected with the rear end of the base frame 10. The rear frame 18 can pivotally move relative to the base frame 10 to fold or unfold the electric bed 1.

The sliding unit 20 includes a frame 22 located above the two guide rails 12, and two slide portions 24 mounted on two end portions of the bottom side of the frame 22, respectively. The frame 22 is used to support the user's buttocks, and the two slide portions 24 are slidably mounted on the two guide rails 12 respectively, so that the sliding unit 20 can reciprocatingly slide forward and backward relative to the base frame 10. Specifically, each slide portion 24 comprises a sliding frame 25 and a plurality of rollers 28 rotatably mounted on the sliding frame 25, abutted against the bottom wall 16 of the one of the two guide rails 12, and located between the vertical wall 14 and the stopping wall 17. Furthermore, the bottom edge 251 of the sliding frame 25 is located between the vertical wall 14 and the stopping wall 17. Each sliding frame 25 has a main section 26 mounted on the bottom side of the frame 22, and an extension section 27 extending forward from the main section 26. However, in other embodiments, the slide portion 24 may be a sliding block made of engineering plastic or other structures, and may not necessarily include rollers 28.

The back supporting unit 30 is pivotally connected at its rear side with the frame 22 of the sliding unit 20 for supporting the user's back. In this embodiment, the back supporting unit 30 includes a skeleton 32 and a bed plate 34, but it can also be replaced with structures having supporting functions, such as metal mesh frames.

Each front linkage 38 is pivotally mounted at its two ends respectively on the guide rail 12 of the base frame 10 and the bed plate 34 of the back supporting unit 30. However, the two front linkages 38 can also be positioned at other locations on the base frame 10 and the back supporting unit 30.

The buttock supporting unit 40 is mounted on the rear frame 18 and adjacent to the sliding unit 20. The buttock supporting unit 40 and the sliding unit 20 are collectively used to support the user's buttocks.

The thigh supporting unit 44 is pivotally mounted at its front side with the buttock supporting unit 40 for supporting the user's thighs, and the lower leg supporting unit 48 is pivotally mounted at its front side with the thigh supporting unit 44 for supporting the user's lower legs.

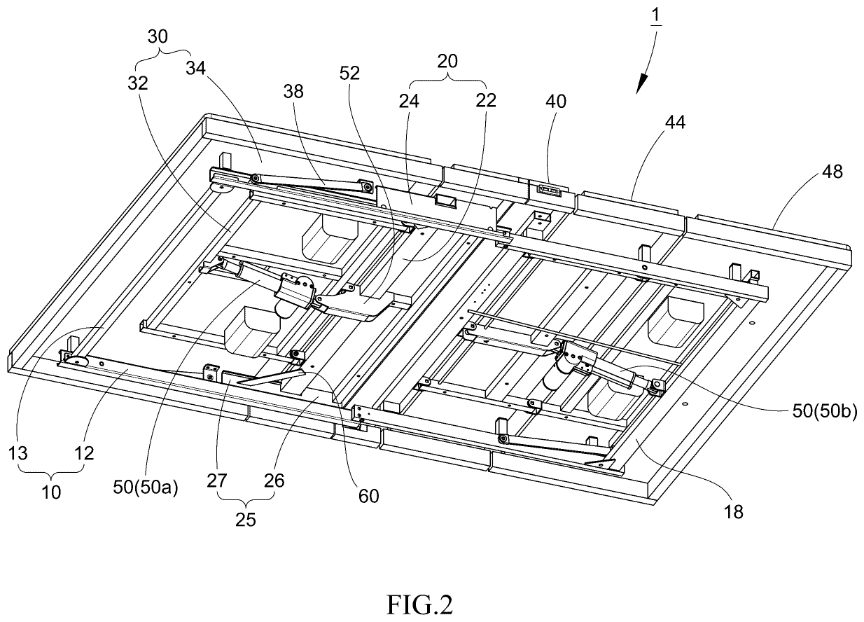

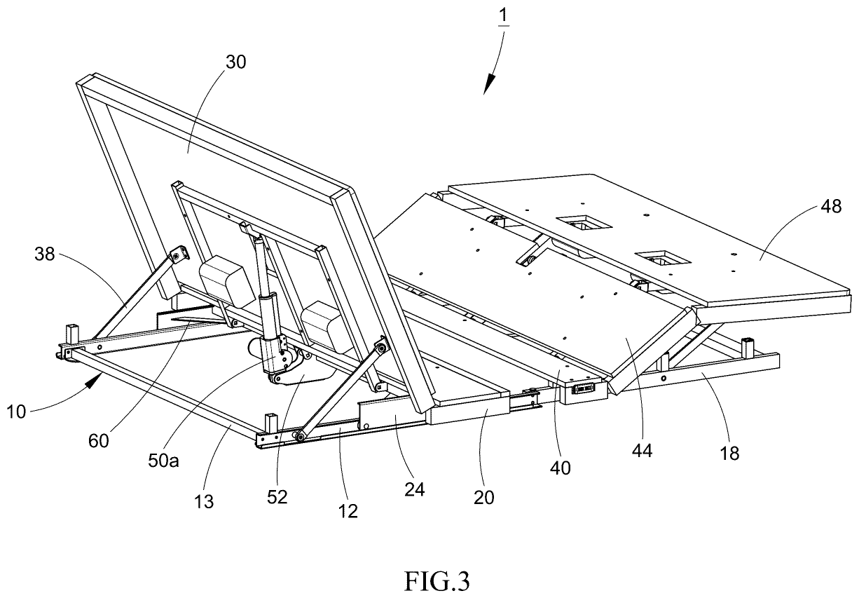

The functions of the two actuators 50 are different. As shown in FIGS. 2 and 3, the actuator 50a located at the front side of the electric bed 1 is connected to the frame 22 via an extension frame 52 and pivotally connected with the back supporting unit 30. Thus, when the actuator 50a extends, it can drive the back supporting unit 30 to swing upward. The two front linkages 38 then pull the back supporting unit 30 forward along with the sliding unit 20, preventing the user from moving away from the head of the bed when the back supporting unit 30 lifts the user's back. The actuator 50b located at the rear side of the electric bed 1 is pivotally connected at its two ends respectively to the thigh supporting unit 44 and the rear frame 18. In this way, when the actuator 50b extends, it can drive the thigh supporting unit 44 to swing upward and raise the lower leg supporting unit 48.

Since the back supporting unit 30 and the sliding unit 20 support most of the user's weight, most of these weights are applied to the bottom walls 16 of the two guide rails 12 through the rollers 28 of the sliding unit 20. The structure of the stopping wall 17 not only greatly strengthens the structural strength of the guide rail 12, effectively avoiding the known deficiency of outward deformation of the guide rail structure, but also confines the sliding frame 25 and the rollers 28 between the vertical wall 14 and the stopping wall 17. In this way, even if the guide rail 12 deforms slightly, it can ensure that the slide portion 24 will not escape from the guide rail 12. To increase the safety factor, two support members 60 may be additionally provided. Each support member 60 is connected to the inner sides of the extension section 27 of each sliding frame 25 and the frame 22 of the sliding unit 20. The two support members 60 are located above the two guide rails 12, which can more effectively prevent the sliding frame 25 from outwardly deformation due to excessive force. With the aforesaid designs, the structural strength of the base frame 10 and the sliding unit 20 is significantly increased, extending their service life, and the increased weight is minimal, with minimal impact on portability, thereby achieving the objective of the present invention.

Based on the technical features of the present invention, various modifications to the electric beds 1 may be made. For example, the structure of the guide rail 12 of the base frame 10 can be applied to the rear frame 18, and the structure of the sliding unit 20 can also be applied to the buttock supporting unit 40. The rear frame 18 may also extend integrally from the base frame 10. Such variations are not to be regarded as a departure from the spirit and scope of the invention, and all such modifications as would be obvious to one skilled in the art are intended to be included within the scope of the following claims.

What is claimed is:

1. An electric bed, comprising:
a base frame comprising two guide rails extending parallel to a back-and-forth direction, wherein each of the two guide rails has a vertical wall, a top wall extending outwardly from at least a part of a top edge of the vertical wall, a bottom wall extending outwardly from at least a part of a bottom edge of the vertical wall, and a stopping wall extending upwardly from at least a part of the bottom wall; and
a sliding unit comprising a frame located above the two guide rails, and two slide portions disposed on a bottom side of the frame, wherein the two slide portions are respectively and slidably disposed to the two guide rails in a way that the sliding unit is reciprocatingly slidable related to the base frame in the back-and-forth direction.

2. The electric bed as claimed in claim 1, wherein the two top walls extend respectively and outwardly from the two vertical walls in opposite directions away from each other, and the two bottom walls extend respectively and outwardly from the two vertical walls in opposite directions away from each other.

3. The electric bed as claimed in claim 1, wherein the two top walls extend respectively and outwardly from the two vertical walls towards each other, and the two bottom walls extend respectively and outwardly from the two vertical walls towards each other.

4. The electric bed as claimed in claim 1, wherein each of the two slide portions includes a sliding frame and a plurality of rollers disposed on the sliding frame, abutted with the bottom wall of one of the two guide rails, and located between the vertical wall and the stopping wall of one of the two guide rails.

5. The electric bed as claimed in claim 4, wherein each of the sliding frames comprises a bottom edge located between the vertical wall and the stopping wall of one of the two guide rails.

6. The electric bed as claimed in claim 4, wherein each of the sliding frames comprises a main section disposed on the bottom side of the frame, and an extension section extending from the main section; the electric bed further comprises two support members, each of which is connected with the extension section of one of the sliding frames and the frame of the sliding unit.

7. The electric bed as claimed in claim 6, wherein the two support members are located above the two guide rails, respectively.

8. The electric bed as claimed in claim 1, further comprising a back supporting unit pivotally connected with the sliding unit, a front linkage having two ends pivotally connected with the base frame and the back supporting unit respectively, and an actuator having two ends disposed on the sliding unit and the back supporting unit respectively in a way that when the back supporting unit is driven by the actuator to swing upwardly, the sliding unit slides forward along the two guide rails.

9. The electric bed as claimed in claim 1, further comprising a rear frame pivotally connected with the base frame.
